(19) United States
(12) Patent Application Publication
(10) Pub. No.: US 2003/0130161 A1
(43) Pub. Date: Jul. 10, 2003

(54) Highly concentrated coconut amido propyl betaine

(76) Inventors: Hendrick Petrus Frick, Ayrshire Scotland (GB); Ajit Kumar, West Midlands (GB)

Correspondence Address: Russell R Stole, Huntsman Corporation, P O Box 15730, Austin, TX, 78761, US

(21) Appl. No.: 10/343,038

(22) PCT Filed: Jun. 4, 2001
(86) PCT No.: PCT/EP01/06335

(30) Foreign Application Priority Data
Jun. 6, 2000 (GB) 001361.3

(51) Int. Cl. C11D 1/00

(52) U.S. Cl. 510/490

(57) ABSTRACT

Uncut CAPB can be prepared at concentrations up to 4% with a set point below 0° C. by reducing the salt content below 5% and preferably below 2% by weight based on the final weight of the product and lowering the pH below 4, preferably below 2.75.

The present invention relates to highly concentrated solutions of coconut amido propyl betaine in the form of mobile liquids and to methods for their preparation.

Aqueous surfactants, are usually only pourable at relatively low concentrations. The formation of immobile or very highly viscous mesophases prevents their being produced and used at higher concentrations, except by using organic solvents, which are undesirable on grounds of cost, fire hazard, environmental impact and possible adverse effects on any formulation in which the surfactant may be incorporated. It is nevertheless desirable that surfactants be supplied at high concentration to give formulators greater flexibility to reduce storage and transport costs and to obviate the need for preservatives.

Most surfactants form clear, mobile, micellar solutions (L₁ phases), which are optically isotropic, Newtonian liquids, up to a critical concentration, which varies considerably from surfactant to surfactant, but is typically around 30% to 35% by weight active matter based on the total weight of the aqueous surfactant. Above this critical concentration, the L₁/M phase boundary, the surfactant forms an immobile phase (the M phase) which is optically anistropic and can usually be recognised by a characteristic texture under the polarising microscope and/or by its hexagonal symmetry when examined by a small angle X-ray spectrometer.

The latter usually reveals one or more peaks the largest of which corresponds to the repeat spacing (d) of the hexagonal array, (given by

$$d = \frac{2 Π}{Q}$$

where Q is the momentrum transfer vector).

Typically for a surfactant mesophase d is in the range 4 to 7 nanometres. In addition to the principal peaks, higher order peals can often be detected. The ratio of the d-spacing of the successive peaks is diagnostic of the symmetry of the system.

The problem of the M-phase can sometimes be avoided by preparing the surfactant at even higher concentrations at which a pourable mesophase, (the L ∝ or G phase) is formed. The G-phase exhibits lamellar symmetry.

Many surfactants only form the G-phase at elevated temperatures, or over such a narrow range of concentrations that it is not commercially practicable to manufacture them in this form.

An alternative approach to the above problem is to add electrolyte which inhibits the formation of the M-phase and so enables the mobile L₁-phase to be obtained at higher concentrations. This is described for instance in EP 0 452 106.

Betaines are an important category of surfactant on account of their mildness, cleaning power and foaming characteristics and are widely used in personal care and detergent formulations. They are usually made by reacting amines with sodium chloracetate. The reaction results in a product containing at least a stoichiometric amount of sodium chloride, which is an unavoidable by product of the reaction, and is usually about 20% based on the weight of active matter. It is also possible to carry out the reaction using potassium or ammonium in place of sodium, but the additional cost is a substantial commercial disadvantage.

Particularly important commercially is coconut amido propyl betaine, commonly referred to as “CAPB”. CAPB has the average formula RCONH(CH₂)₃N⁺(CH₃)₂CH₂COO⁻ where R represents a mixture of alkyl chain lengths corresponding on average to those present in unrefined coconut or palm oil fatty acids. Typically coconut fatty acids contain a mixture of fatty acids having 8, 10, 12, 14, 16 and 18 carbon atoms in which lauric acid (C₁₂) is the main component. The term CAPB is often used broadly to include amido propyl betaines obtained from other fatty acid feedstocks having the same or similar distribution to coconut fatty acid.

Coconut fatty acids are usually hardened by hydrogenating at least part of the unsaturated components, and in addition may be “cut” by removing the C₈₋₁₀ fatty acids. They may be further refined to remove the C₁₄₋₁₈ fatty acids to leave substantially pure (i.e. greater than 90%) lauric acid.

This invention is concerned with “uncut CAPB” which term is used herein to describe CAPB prepared from natural or hydrogenated, uncut coconut or palm fatty acids or from a natural or synthetic fatty acid feedstock or mixture of feedstocks having a substantially equivalent alkyl distribution. For most purposes uncut CAPB is preferred on cost grounds.

Uncut CAPB is normally available in a pourable form of up to about 34% above which it forms immobile or viscous mesophases, typically the isotropic I₁ phase, which may exhibit cubic symmetry. Higher concentrations have been claimed using various additives and/or solvents. For example U.S. Pat. No. 4,832,871 relies upon organic solvents and the use of potassium or ammonium salts to achieve high concentrations. U.S. Pat. No. 5,353,906 claims relatively high concentrations by use of a fatty acid additive and optionally, glycerol as a solvent. DE 19700798A describes the use of polycarboxylic acids such as citric acid. U.S. Pat. No. 4,861,517 describes the use of mineral acids to lower the pH of the betaines to obtain relatively high concentrations. However at the higher concentrations described in this patent, the compositions made by the above method are only pourable at the elevated temperatures used to concentrate them. Moreover even at such elevated temperatures they form viscous mesophases comprising the hexagonal M phase. At normal temperature they set to form opaque, non pourable pastes.

We have previously shown (see GB1525 692) that betaines can be obtained, at higher concentrations than normal as clear, mobile, optically isotropic micellar solutions at ambient temperatures by reducing the salt content. However at such raised concentrations, uncut CAPE has an undesirably high set point.

We have now found that for uncut CAPB even higher concentrations can be achieved if the pH of the desalted product is lowered, eg by adding mineral acids. A beneficial effect of mineral acid was noted by Bade et al in U.S. Pat. No. 4,861,517. However at the high salt levels present in Bade's compositions an L₁ phase was not obtained at high concentrations, as can be seen from Bade's description of his product as cloudy. In fact Bade's products, as prepared in his examples comprised a substantial proportion of mesophases including the viscous hexagonal phase even at the elevated temperatures at which he was evaporating his compositions. At normal temperatures Bade's products are pastes.

The novel concentrated CAPB of our invention is obtainable as a clear mobile L1 phase at even higher concentrations than those of Bade, and at normal temperatures.

The novel L₁ phase of our invention typically sets, on cooling to a sufficiently low temperature, usually to a ringing gel, which is an optically clear and isotropic mesophase having, typically, a cubic symmetry. One effect of the low pH of our invention is to depress the set point below 0° C., which is desirable for a fully commercially acceptable product.

According to a first embodiment our invention provides an uncut CAPB composition comprising water and uncut CAPB wherein the concentration of sodium chloride is less than 6% by weight of the composition, the pH is below 4 and the concentration of amphoteric surfactant is above 38% such that the composition is able to form a clear L₁ phase at 25° C.

Preferably the uncut CAPB is derived from a feedstock containing from 40 to 55% by weight C₁₂ fatty acid; from 10 to 20% by weight, preferably 12 to 18% of fatty acids less than C₁₂; and from 20 to 50% by weight, preferably 30 to 40% of fatty acids greater than C₁₂. Typically the proportion less than C₈ is less than 2%, more usually less than 1% by weight. The proportion greater than C₁₈ is typically less than 2% more usually less than 1% by weight.

According to a preferred embodiment the concentration of amphoteric active surfactant is at least 40% by weight of the composition the sodium chloride content is below 5% by weight of the composition and the pH is below 4.

According to an alternative preferred embodiment the amphoteric active surfactant content is greater than 38% the sodium chloride content is less than 6% and the pH is less than 2.75.

The composition is preferably an aqueous uncut CAPB composition wherein the surfactant is present as an L₁ phase which sets on cooling to a gel said composition having a pH sufficiently low to maintain the set point below 20° C., preferably below 10% most preferably below 0° C. Typically the gel phase is an isotropic cubic phase.

The invention according to a further embodiment provides a method of preparing a highly concentrated, L₁ phase, uncut CAPB by reacting an uncut coconut amido propyl amine with sodium chloracetate to form a reaction product comprising said uncut CAPB at an active concentration below 38% by weight and sodium chloride at a concentration above 15.75% by weight based on the weight of surfactant, characterised in that: (i) the sodium chloride concentration of said reaction product is reduced to a value less than 15% based on the weight of surfactant; (ii) before, during or after (i), the pH is reduced below 4; and (iii) simultaneously with or after (i) and (ii) the concentration of surfactant in said reaction product is raised to a value greater than 38% by weight based on the weight of the composition, whereby an L₁ phase is maintained.

The pH of the composition is adjusted preferably below 3 e.g. by addition of mineral acid e.g. hydrochloric, sulphuric on phosphoric. We particularly prefer that the pH is between 1.5 and 3 e.g. 2 to 2.5.

The inorganic salt content is preferably from 0.01 to 5% especially from 0.1 to 2.5% e.g. 0.5 to 1.75% based on the weight of the composition. The amphoteric concentration of uncut CAPB is preferably greater than 40% especially 41 to 46 e.g. 42 to 44%.

In order to obtain the low salt contents which are an essential feature of the invention it is generally necessary to remove salt from the uncut CAPB as originally prepared.

Salt may be removed from amphoteric surfactants, either during or after preparation, for example by electrodialysis, e.g. as described in our GB 1 525 692 or in EP 0 736 521, by membrane filtration, for example as described is EP 0 626 881, or, less preferably, by displacing metal ion e.g. using ion exchange or by solvent precipitation. Alternatively, it is possible to prepare betaines with low salt levels by quarternising with acrylic acid.

The term salt as used herein includes any water soluble non-surfactant salt which normally lowers the solubility of surfactants in water. Typical examples are inorganic salts such sodium, potassium or ammonium chloride, sulphate, silicate or carbonate and lower molecular weight carboxylates such as acetates, benzoates, citrates or succinates of alkali metals or ammonium. Typically the salt is sodium chloride, or more rarely, potassium or ammonium chloride formed as a by-product of the quaraternisation of the amine with chloracetate.

The removal of water may be effected by evaporation e.g. by heating and/or the application of reduced pressure, or as a consequence of an electrodialysis or membrane filtration desalting step.

We prefer that uncut CAPBs of our invention contain less than 5% by weight, more preferably less than 1.5% and most preferably less than 0.7% of free fatty acid, measured at 40% active concentration.

We prefer that uncut CAPB of our invention contain less than 3% by weight, more preferably less than 1.5%, most preferably less than 0.7% free amido amine, measured at 40% active concentration.

An important advantage of the invention is that increased concentrations of uncut CAPB are available without the requirement for solvents or other additives. We prefer that solvents and organic additives be substantially absent. However, for some purposes their presence may be tolerable or even desired. Thus amphoteric surfactants according to our invention may be blended with other surfactants where such blends are specifically required. The compositions may contain small amounts of adventitious fatty acid, formed as a by-product or decomposition product during manufacture or storage. Small amounts of solvent may optionally be present if desired, e.g. water soluble mono-, di- and polyhydric alcohols and alcohol ethers, aldehydes and ketones, including ethanol, isopropanol, ethylene glycol, glycerol diethylene glycol, acetone or methyl isobutyl ketone. Other organic additives such as citric acid and preservatives could be included if desired. We generally prefer, however, that the total amounts of solvent and organic additives be less than 20% of weight of the composition e.g. less than 5%, especially less than 2%, particularly less than 1% most preferably below 0.5%. The low content of salt, water, solvent and other additives that can be obtained is of value to formulators since they are less constrained in the range of formulation that they can achieve. Products of our invention generally do not need preservatives.

We prefer that the compositions consist essentially of amphoteric surfactant and water. By that we mean that, apart from the specified levels of inorganic salt and water, other components are substantially absent or present only in trivial or adventitious amounts.

Preferably the fatty acids are from 50% to 100% hydrogenated e.g. more than 75% hydrogenated, especially more than 90% hydrogenated.

The invention is illustrated by the following examples in which all percentages are by weight and % of alkyl species are expressed as % by weight of the specified alkyl amido propyl betaine based on total alkyl amido propyl betaine unless otherwise stated:

### COMPARATIVE EXAMPLE

Commercial uncut CAPB sold under the Registered Trademark “EMPIGEN BSMA” has the following composition:

| Active (MW350) | 30% |
|---|---|
| Sodium chloride | 5.61% |
| Free fatty acid (208) | 0.46% |
| Free amido amine (292) | 0.22% |
| pH | 5.03 (as is) |
| C₈ | 8.5% |
| C₁₀ | 6.7% |
| C₁₂ | 49.5% |
| C₁₄ | 19% |
| C₁₆ | 8.8% |
| C₁₈ | 7.6% |
| C_{18:1} | less than 1% |
| (a) Water was removed by evaporation from the above commercial composition until the concentration reached 34% active. | |
| # The composition was a clear, non-pourable cubic phase gel at 25° C. | |
| (b) Salt and water were removed from the commercial composition until the salt content was 0.19% and the active concentration | |
| # was 39.5%. The composition was pourable at 25° C. but with a high set point. However any further concentration or reduction in | |
| # temperature below 25° C. gave compositions which were non-pourable, viscous isotropic phases. | |
| (c) The commercial composition was acidified to pH 2 at 30% active with hydrochloric acid and concentrated to 39% active. The | |
| # product was a viscous opaque paste at 25° C. which had a viscosity of 80 Pa s at 1 sec⁻¹ and which was | |
| # a mixture of hexagonal and lamellar phases, according to X-ray scattering and polarising microscopy. | |

### COMPARATIVE EXAMPLE

Commercial lauryl amidoproply betaine (LAPB) sold under the Registered Trademark “EMPIGEN BR” has the following composition:

| | |
|---|---|
| Active (MW342) | 30% |
| Sodium chloride | 5.2% |
| Free fatty acid (200) | 0.3% |
| Free amido amine (284) | 0.4% |
| pH | 11.7 (asis) |
| C₁₂ | 99% |

The commercial composition was acidified with hydrochloric acid and simultaneously water and salt were removed to reduce salt concentration to 0.06%, raise the active concentration to 40.7% and reduce the pH to 2. The product was a clear, mobile, Newtonian, phase at 25° C. Any further concentration led to a non-flowable gel phase being obtained.

### COMPARATIVE EXAMPLE

Commercial “topped” hardened CAPB, where a significant fraction of the C₈₋₁₀ chain lengths have been removed, is sold under the Trademark “EMPIGEN BSFA” and has the following composition:

| | |
|---|---|
| Active (MW358) | 30% |
| Sodium chloride | 5.2% |
| Free fatty acid (216) | 0.4% |
| Free amido amine (300) | 0.4% |
| pH | 5.5% (as is) |
| C₈ + C10 chains | <1% |
| C₁₂ | 57% |
| C₁₄ | 20% |
| C₁₆ | 11% |
| C₁₈ | 11% |

The commercial composition was acidified with hydrochloric acid and simultaneously water and salt were removed to reduce salt concentration to 0.12%, raise the active concentration to 41.5% and reduce the pH to 2. The product was a clear, mobile, Newtonian, phase at 25° C. Any further concentration or cooling to below 25° C. led to a viscous non pourable gel in the viscous isotropic phase being obtained.

### EXAMPLE

The commercial composition was acidified with hydrochloric acid and simultaneously water and salt were removed to reduce the salt concentration to 1%, raise the active concentration to 45% and reduce the pH of the final product to 2. The product was a clear, mobile, Newtonian, liquid phase at 25° C. with a viscosity of less than 0.4 Pa s. The composition remained a clear and pourable L₁ phase when cooled to 0° C.

The behaviour of the uncut CAPB was surprising because it appears to differ markedly from that of other betaines, and even from cut CAPB. Amphoacetates are notoriously sensitive to acidification which substantially raises their viscosity. They are generally unpourable unless maintained at alkaline pH. The invention does not work for alkyl dimethyl betaines including those derived from cut and uncut coconut feedstocks and the comparative examples show that it is also ineffective with more refined derivatives of CAPB including cut CAPB and LAPB.

1. An uncut CAPB composition comprising water and uncut CAPB wherein the concentration of sodium chloride is less than 6% by weight of the composition, the pH is below 4 and the concentration of amphoteric surfactant is above 38% and such that the composition is able to form a clear L₁ phase at 25° C.

2. A composition according to claim 1 wherein the uncut CAPB is derived from a feedstock containing from 40 to 55% by weight C₁₂ fatty acid; from 10 to 20% by weight of fatty acids less than C₁₂, and from 20 to 50% by weight of fatty acids greater than C₁₂.

3. A composition according to claim 1 wherein the concentration of amphoteric active surfactant is at least 40% by weight of the composition the sodium chloride content is below 5% by weight of the composition and the pH is below 4.

4. A composition according to claim 1 wherein the amphoteric active surfactant content is greater than 38% the sodium chloride content is less than 6% and the pH is less than 2.75.

5. A composition according to any foregoing claim wherein the surfactant is present as an L₁ phase which sets on cooling to a gel said composition having a pH sufficiently low to maintain the set point below 20° C.

6. A composition according to claim 5 having a set point below 0° C.

7. A method of preparing a highly concentrated, L₁ phase, uncut CAPB by reacting an uncut coconut amido propyl amine with sodium chloracetate to form a reaction product comprising said uncut CAPB at an active concentration below 38% by weight and sodium chloride at a concentration above 15.75% by weight based on the weight of surfactant, characterised in that: (i) the sodium chloride concentration of said reaction product is reduced to a value less than 15% based on the weight of surfactant; (ii) before, during or after (i), the pH is reduced below 4; and (iii) simultaneously with or after (i) and (ii) the concentration of surfactant in said reaction product is raised to a value greater than 38% by weight based on the weight of the composition, whereby an L₁ phase is maintained.

8. A method according to claim 7 wherein the pH is adjusted to between 1.5 and 3.

9. A method according to either of claims 7 and 8 wherein the inorganic salt content is reduced to form 0.1 to 2.5% based on the weight of the composition.
